(19) United States
(12) Patent Application Publication
(10) Pub. No.: US 2022/0001428 A1
(43) Pub. Date: Jan. 6, 2022

(54) METHOD OF BACK-PULSE FLUSHING CLOGGED PIPES, FOR EXAMPLE IN A HYDRAULIC PIPE SYSTEM

(71) Applicant: Ocean Team Group A/S, Esbjerg (DK)

(72) Inventors: Jens Peder Høg Thomsen, Varde (DK); Espen Kähler Amundsen, Haderslev (DK)

(21) Appl. No.: 17/293,998

(22) PCT Filed: Nov. 15, 2019
(86) PCT No.: PCT/DK2019/050352

§ 371 Date: May 14, 2021

Related U.S. Application Data
(60) Provisional application No. 62/767,719, filed on Nov. 15, 2018.

(51) Int. Cl. B08B 9/032

(52) U.S. Cl. CPC B08B 9/0326

(57) ABSTRACT

Various embodiments of the present disclosure are directed to methods of removing liquid from a lumen of a hydraulic control line by a back-pulse flushing procedure. In one example embodiment, the back-pulse flushing procedure includes pressurizing the hydraulic control line to a pressure P1 by adding pressurized carbon dioxide into a first end of the hydraulic control line, where the carbon dioxide is in a liquid or supercritical state, maintaining the carbon dioxide in the liquid or supercritical state while the carbon dioxide diffuses through and accumulates in the matter, and depressurizing the hydraulic control line to cause the carbon dioxide to change into a gas state and press the matter out of the first end of the hydraulic control line.

### FIELD OF THE INVENTION

The present invention relates to a method for cleaning of pipes, in particular by flushing the lumen of long, thin pipes, especially fluid control lines, such as hydraulic control pipes for actuators in underwater valve systems.

### BACKGROUND OF THE INVENTION

Hydraulic control pipe systems for controlling subsea valves in petrochemical industry are subject to accumulation of unwanted materials and impurities not only on the pipe walls but also in the valve itself, which can be detrimental for the functioning of valve. In the case where the hydraulic pipe system uses an oil-based fluid, the impurities or dirt that accumulated on the inside of the hydraulic pipe system is usually wax or grease. The impurities, including particulate matter, may also be accumulated in valves used in deep-sea installations with the risk of malfunctioning.

Malfunctioning of valves can lead to severe environmental accidents, for example when oil pipes are not closed properly and spilled into the sea water. As such unwanted materials or impurities result in reduced operational safety, there is a desire to provide a cleaning method.

The problem with hydraulic valve actuators in oil and gas production is discussed in US2003/094419 by Vickio, in which it is proposed to use hydraulic fluid at turbulent flow through the hydraulic system.

For the case that the valve can be opened, and liquids can be flushed through the valve, US patent application US2016/184871 by Thomsen et al. and assigned to Ocean Team Group A/S proposes a method where supercritical carbon dioxide, scCO2, or liquid carbon dioxide, LCO2, is flushed through the pipe under turbulent conditions.

CN106623275A discloses use of scCO2 in oil pipes for removing fouling.

However, for control lines for valves that cannot be flushed through because there is no opening at the valve, this method does not apply. For cleaning, the valve would have to be demounted, for which typically the entire pipe system, typically having a length in the order of 200 to 1000 meter, would have to be lifted up to the surface. This implies high costs and efforts, and the operation of the oil recovery system related to the valve would be halted, which is not desirable.

In order to clean pipe systems, it has been proposed to use turbulent flow in such pipes with a cleaning and flushing liquid. The turbulent flow assists in loosening contaminants that adhere to the inner wall of the pipes and flush away the contaminants. In the UK patent application GB2323421 by Thomsen, assigned to Ocean Team Scandinavia, a system is disclosed with fluid pipes are cleaned with a pulsated flow. In order to obtain a turbulent flow, a Reynolds number of at least 2300 or at least 3000 is mentioned

When narrow pipe systems get very long, the pressure drop of the cleaning fluid throughout the pipe results in loss of turbulent flow, because the speed of the flow cannot be kept high enough. This problem is discussed in patent U.S. Pat. No. 5,007,444 by Sundholm; the pressure drop in pipes that are longer than 200 m and with a narrow lumen of 10 mm prevent a flushing speed that creates a turbulent flow, because the pressure required at the entrance of the tube to compensate for the pressure loss along the pipe and for create the necessary flow speed would exceed the pressure that the pipes typically withstand. As a solution to this problem, U.S. Pat. No. 5,007,444 proposes filling the pipe system with flushing liquid as well as nitrogen gas such that number of portions of flushing liquid in the pipe is separated by gas portions. The gas in the alternating columns of oil and gas is compressed for subsequent expansion when a valve at the end of the pipe is opened in order to create a forceful flushing pulse through the pipe system.

For cleaning and flushing of pipe systems, heat exchangers, condensers and catalysers, liquid carbon dioxide (LCO2) or supercritical carbon dioxide (scCO2) has been proposed in German utility model DE20113516U1 by Kipp. As illustrated in the figures of DE20113516U1, LCO2 or scCO2 is led into the bottom of a heat exchanger and extracted through a top valve before being filtered as gas and recirculated. In DE20113516U1, no details are given with respect to flow speed or pressure other than the pressure and temperature necessary to keep the carbon dioxide, CO2, in a liquid or supercritical state. It is explained that the LCO2 and the scCO2 would loosen the contamination from the inner walls.

Rinsing cavities with supercritical CO2 is disclosed in US2009/0107523 by Zorn. CO2 gas as a flushing in submarines is disclosed in European patent application EP2151377 by Krummerich et al. FR2918167 discloses CO2 for cleaning heat exchangers. U.S. Pat. No. 5,375,426 by Burgener discloses scCO2 for cleaning a refrigeration system. JPH10258019 concerns scCO2 for cleaning of endoscopes. Use of hydrocarbon fluids for cleaning a chemical or hydrocarbon processing plant is disclosed in WO2003/103863. Substrate cleaning with scCO2 is disclosed in WO2003/046065 by Bertram et al. US2013/0074943 by Cloeter discloses scCO2 for solubilizing a surfactant for enhanced oil recovery. U.S. Pat. No. 8,517,097 by Segerstrom discloses scCO2 for mixing with heavy crude oil to reduce the viscosity and ease transportation of oil through pipes. DE4423188A discloses cleaning of gas containers. US2009/0107523A1 discloses flushing with CO2 of bore holes in work pieces in automobile industry.

It appears from the above prior art that cleaning with CO2 in liquid form or in supercritical state is common practice for hydraulic pipes when the CO2 is inserted at one end and released at the opposite end.

However, these methods are not applicable for hydraulic pipes to actuators in control valves, where the pipe has a dead end which is not accessible. Accordingly, there is a need for further improvement in the art.

### DESCRIPTION OF THE INVENTION

It is an objective for the present invention to provide an improvement in the art. In particular, it is an objective to provide a method for cleaning fluid control pipes, for example hydraulic pipes, which are dead-end pipes or where release of the fluid, for example hydraulic fluid, at the remote end cannot be released, for example due to environmental reasons. In particular, it is an objective to provide a cleaning method for hydraulic pipes to actuators in subsea control valves, especially in oil and gas industry.

This objective is achieved with a method in which matter, such as clogging matter, is removed from a lumen of a pipe, such as a clogged pipe, by a back-pulse flushing where carbon dioxide in liquid or supercritical state is added to a pipe for the CO2 to diffuse into and through the matter in the pipe, after which the pressure is reduced. The pressure reduction changes the CO2 into expanding gas that presses the matter out of the pipe at the same end into which the CO2 was inserted.

The method is useful for cleaning long dead-end pipes, for example hydraulic control pipes for valves in offshore installations, especially in oil and gas industry. It is advantageously applied in repeated cycles to remove the matter from the pipe in portions. The method is useful for other types of pipes, in particular other types of fluid control pipes and also for chemical injection pipes. For example, the pipe is part of an umbilical, in particular offshore umbilical, optionally of the type used for subsea industry.

For example , the matter in the pipe, typically, contains viscous solid, for example wax or grease, and potentially also solid particles, optionally also liquid, such as hydraulic fluid. In hydraulic pipes, the hydraulic liquid, for example oil, may have changed into sludge, also called grease or wax. This can range from solid over viscous solid to liquid state. Sludge can clog the lines such that transport of liquid through the pipe is no longer satisfactory, for example not any longer possible or at least not possible to a level that ensures proper functioning of the equipment.

Also, particulate matter can be part of the sludge. Another risk is accumulation of sludge and/or particulate matter in equipment that is connected to the pipe and driven by the hydraulic fluid. For example, hydraulic valve systems are at risk for being clogged and malfunctioning due to sludge and particulate matter.

The back-pulse flushing cycle comprises

pressurizing the pipe to a pressure P1 by adding pressurized carbon dioxide into the pipe at a first end of the pipe;

adding the pressurized carbon dioxide at a temperature T, which at the pressure P1 is in a liquid state, LCO2, or in a supercritical state, scCO2;

maintaining the carbon dioxide in a liquid state or in a supercritical state, respectively, in the pipe for a time t for diffusion of the LCO2 or scCO2 through the matter during a time t, optionally accumulating the LCO2 or scCO2 not only inside the matter but also on the opposite side of the matter;

then, after the time t, depressurizing the pipe at the first end to a lower pressure level, for example atmospheric pressure, where the carbon dioxide changes into expanding gas inside the pipe and pressing the matter out of the pipe through the first end of the pipe by the expanding gas.

In more detail, carbon dioxide, CO2, is provided at a pressure and a temperature, where the carbon dioxide is in a liquid state, LCO2, or in a supercritical state, scCO2. In order to maintain the CO2 in a liquid or supercritical state, the pressure of the pipe is adjusted correspondingly, for example to the same pressure or only slightly lower pressure, or even a higher pressure. Important is that the pressure level P1 in the pipe is not causing the CO2 to change into a gaseous state when entering the pipe and flowing to the position of the matter that is to be removed.

The LCO2 or scCO2 is diffusing through the matter along a part of the pipe and accumulates inside the matter and/or on the other side of the matter, the latter being a special situation if the matter is a plug of grease that is clogging the pipe. The diffusion may be assisted by gravity. By sufficiently depressurising the pipe, the CO2 changes into a gaseous state, where it builds up pressure inside the matter or on the other side of the plug. The pressure causes expansion of the gas and presses the matter out of the first end, especially if the pipe is a dead end pipe or if the pipe is very long such that displacement of the material to the other end and out of the other end is much harder than pressing the matter out of the first end. The method is useful for cleaning pipes from the first end only.

The cleaning from one end only has a great advantage in offshore installation for oil and gas recovery in that the operation of the oil or gas plant is not necessary to stop, which saves high costs.

Experimentally, satisfying results have been achieved with both LCO2 and scCO2. However, the selection of either of the states depends on the circumstances. If the pipes are cold, for example in deep seawater, it can be difficult to keep the supercritical state, which requires a temperature above the critical temperature Tc=31° C. (degrees centigrade). In such cases, use of LCO2 can be advantageous over scCO2. However, in oil pipes during pumping operation, the temperature can be above 31° C., why scCO2 can be used with success. For example, the scCO2 is added to the pipe at a higher temperature than the pipe has itself, optionally at a temperature in the range of 60 to 200 degrees centigrade. As compared to LCO2, the supercritical state has lower diffusivity and viscosity and tend to penetrate the matter easier and faster. Also, in the case that the matter to be removed is far down in a narrow tube, the scCO2 flows easier and faster through the tube.

The latter is of high interest when the back-pulse flushing procedure for removing matter is repeated cyclically multiple times, for example in the range of 3-50 times, for removing matter in minor portions step by step. For example, the CO2 may penetrate the matter over a distance of a few meter and be used to remove portions of matter from the pipe where each portion corresponds to a volume that fills a few meter of the pipe.

For example, the pipe is pressurized to a pressure P1 above the critical pressure, Pc=7.39 MPa, of carbon dioxide. The carbon dioxide is then added as scCO2 at a temperature T above the critical temperature Tc=31° C., for example in the range of 60 to 200 degrees centigrade. Typically, the pressure P1 is far above the critical pressure, for example in the range of 10 MPa (100 bar) to 100 MPa (1000 bar). After the dwell time of t, in which the LCO2 or scCO2 has diffused into and through the matter, the pressure is lowered at the first end to a level P2, for example to atmospheric pressure (1 bar), in order to press the matter out of the pipe by the expanding gas.

In experiments, where hydraulic pipes under seawater have been cleaned with CO2, each flushing cycle can have a dwell time t of the CO2 which varies broadly, For example, for a clogged hydraulic line, the clogging may take up to three days to penetrate. On the other hand, if the hydraulic fluid is still liquid, especially if the clogging has been removed, the dwell time t is in the order of minutes. The time t therefore is in the range of a minute to 72 hours, typically however in the range of 0.1 hour to 12 hours. For example, the first cycle implies a dwell time tin the range of 2 to 72 hours and the subsequent cycles a time tin the range of 0.1-12 hours, potentially in the range of 0.1 to 2 hours.

The method can be used to clean and empty even very long pipes of narrow diameter, for example several kilometers long and with a diameter of less than 13 mm.

Useful when flushing such pipe that contains liquid, for example hydraulic liquid, such as oil, is a turbulent flushing. In order to press the matter through the pipe to the first end of the pipe under turbulent conditions, the related Reynolds number has to be high enough, for example at least 3000. However, experiments have been made, where the Reynolds number was above 5000, for example in the range of 10000 and 30000.

The Reynolds number is defined as Re=density*velocity*diameter/viscosity and can correspondingly be calculated for the matter during the back-pulse flushing and also for the LCO2 or scCO2 travelling down the pipe towards the matter in the cycles.

For example, the Reynolds number can be determined in the following procedure. By measuring the volume of matter that has been removed from the pipe for each of the multiple back-pulse flushing cycles and knowing the pipe diameter, the length of the already flushed part of the pipe can be calculated, where the flushed part is that part of the pipe from which matter has been removed during the corresponding cycles. The lengths of the flushed part as summed from all the already performed cycles is yielding the depth inside the pipe at which the next cycle has to remove matter. The depth gives the distance from the first end to the matter that is to be removed in the next cycle. With the calculated distance and a measured time lag between the depressurization of the pipe and the arrival of the matter at the first end of the pipe, an average velocity of the matter can be calculated. By also determining or estimating the density and the viscosity of the matter, the Reynolds number can be calculated on the basis of the average velocity.

Already when filling CO2 into the pipe, it is advantageous to create turbulence for the CO2, as this turbulence cleans the pipe walls. For LCO2, turbulent flow is expected for a Reynolds number of at least 2500, for example at least 3000. This number is very much like the corresponding estimate for flushing oil. For SCCO2, the Reynolds number for turbulent flow is about an order of magnitude higher, for example at least 17,000 or at least 20,000 or thus at least 25,000.

For example, the speed of the CO2 through the lumen is at least 0.5 m/sec, for example at least 1 m/sec or at least 1.5 m/sec or at least 2 m/sec. However, this also depends on the cross section in the tube, and turbulent speed can potentially be achieved with speed as low as 0.2 or 0.3 m/sec.

However, in case that the SCCO2 is filled into a lumen of a pipe that is very long, for example more than 500 m long, and extends into sea water, the temperature of the sea water would result in a temperature drop inside the tube which may cause a change of the supercritical state into a liquid state. As there is an interest of keeping the CO2 in a supercritical state for relatively long inside the lumen, the speed should of the CO2 not become too low. A speed of at least 1.5 m/sec has been found to be a good selection in such cases, although the speed may be lower or higher in dependence of the surrounding conditions, for example cold sea water, which influence the temperature drop. The advantage of SCCO2 as compared to LCO2 is the lower viscosity, which allows a higher flow rate at relatively low pressure drop through the tube. The higher flow rate is a good measure against early temperature decrease below the critical temperature.

Typical cross sectional sizes of pipes for underwater hydraulic pipes in gas and oil industry are less than 150 mm2 (square millimeter) and typically at least 3 mm2. For example, the pipe is a hydraulic dead-end pipe for hydraulic actuation of an actuator in a valve of an offshore installation, the pipe having a cross sectional area of at least 1 mm2 and less than 150 mm2 and a length of more than 100 m, typically in the range of 0.1-10 km, although even longer lengths are possible.

For example, experimentally a quarter inch lumen of a 6500 m long pipe was cleaned with such method. The pressure used was 350 bar, and the temperature 80.

In another experiment, a chemical injected fluid had become very thick and sticky, and the hydraulic line could not be used. During this back-flushing experiment, 28,4 liter of matter was removed from the one-way line. This volume was equivalent to 2,4 km line that had been back-flushed, out of a total line of 3 km with and inner diameter of 7 mm. When the CO2 is flushing the matter out of the pipe, the CO2 can easily be recovered and used in subsequent back-pulse flushing cycles.

In some embodiments, the LCO2 or scCO2 is provided with a content of surfactant, wherein the volume of the surfactant relatively to the volume of the LCO2 or scCO2 is typically in the range of 1-5%. For example surfactants with long-chained hydrocarbons are used or surfactants with aromatic rings. Possible surfactants are cyclic hydrocarbon solvent, dipropylene glycol mono n-butyl ether, alcohol ethoxylate, or ethoxylated alkyl mercaptan.

For refilling hydraulic liquid back into the pipe, after removal by the method as described above, in some embodiments, pressure is maintained at elevated level in the pipe and the clean hydraulic liquid is added while the pipe is kept under pressure. The CO2 is then removed displacing it with the hydraulic liquid before the pressure is lowered again.

For example, the cross sectional area of the lumen is 30 square mm and the length more than 1000 m; the speed of the CO2 through the pipe during the flushing step is at least 0.5 m/sec, optionally at least 1.5 m/sec, and the Reynolds number is at least 2,500 if the CO2 is in the liquid state and at least 17,000, optionally at least 25,000, if the CO2 is in the supercritical state.

The cross section of the pipe system is in one simple case circular with a given diameter. Alternatively, the cross section can be shaped as an ellipse, a curved free form, or a polygon or even a combination thereof. The cross section can be uniform or non-uniform along the whole length of the pipe, although, typically, it will be uniform. The pipe can be straight or curved, for example having one or more bends. For example, the pipe is made of metal, such as stainless steel or nickel alloys, or a polymer/metal combination. Optionally, it has a uniform circular cross section with an inner diameter in the range of 3 to 6 mm and a length of at least 100 m.

To enable the pressurizing of the CO2, a compressor or pump is connected to the first end of the pipe by fittings. Typically, the system is configured for recycling the CO2 after flushing of the pipe. The system comprises the following elements:

a compressor or pump for varying the pressure of the CO2,

a heater for controlling the temperature of the CO2 at the first end of the pipe,

a flush tank for receiving the back-pulse flushed matter from the pipe system,

a reservoir for storing the matter and for extracting CO2, for example for recycling;

connectors at the first end of the pipe for connecting to the pipe so that the CO2 can enter the pipe at the first end, flow through the pipe to the matter in the pipe and return to the system before the next cycle, and with

connectors between the elements.

According to an embodiment of the invention, the flushing system further includes a system of sampling filters placed after the return point of the CO2 and is configured for cleaning the CO2 from impurities and for check of the cleanliness by a particle counting method.

### DESCRIPTION OF THE DRAWING

This invention will be described in relation to the drawings, where:

FIG. 1 shows a sketch of an offshore installation

FIG. 2 is a diagram showing Reynolds number from flushing contaminations in an oil pipe;

FIG. 3 is a diagram showing the gradual cleanliness of the pipe in terms of the NAS1638 standard:

FIG. 4 is a table for the definition of the NAS 1638 standard;

FIG. 5 is a diagram Reynolds number during filling of the pipe with scCO2.

### DETAILED DESCRIPTION OF THE INVENTION

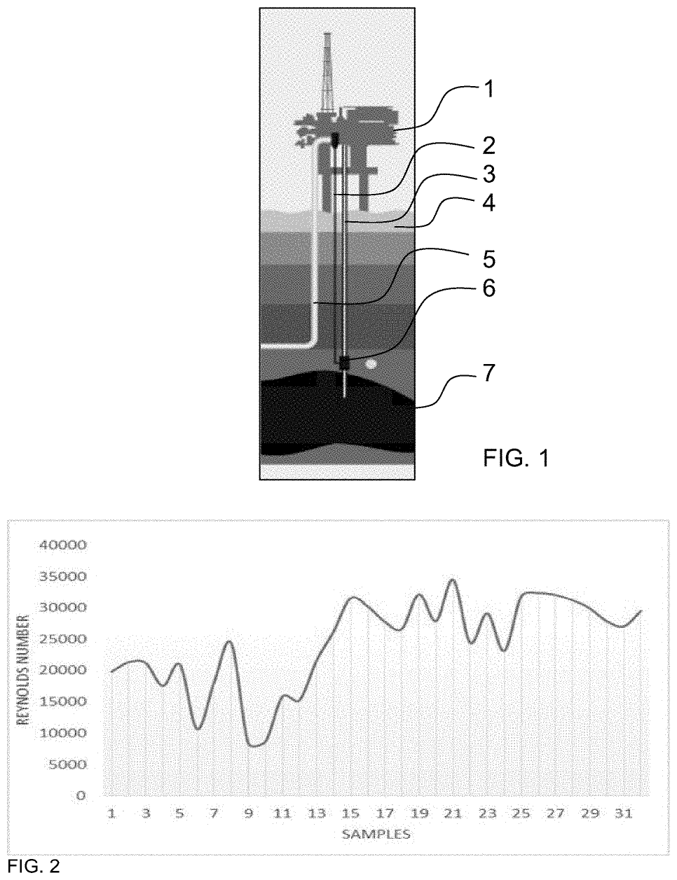

FIG. 1 shows a sketch of an offshore installation 1, which is an oil or gas rig in sea water 4. Oil or gas from a well 7 is pumped through a tube 3 to the rig 1 and pumped from there through an umbilical to an accumulator, for example a vessel. The tube 3 can be closed off by a valve 6, which is important for safety reasons, especially environmental protection in case of problems. The valve 6 comprises a hydraulic actuator that is operated by hydraulic fluid in hydraulic pipe 2. In contrast to the oil transporting tube 3, the hydraulic pipe 2 has a much smaller diameter, typically in the order of 5 mm to 13 mm, such a quarter inch pipe or a half inch pipe, which is a commonly used pipe size for this purpose.

With time, the hydraulic fluid, for example oil, in the hydraulic pipe 2 increases in viscosity and sludge may be deposited not only on the walls of the pipe but also in the valve, especially in the actuator, in addition to particles from the hydraulic fluid or from the mechanical components in the tube and valve system. Sludge can plug the lines such that transport of liquid through the pipe is no longer possible or at least not possible to a level that ensures proper functioning of the equipment. Also, particulate matter can become part of the sludge. Another risk is accumulation of sludge and/or particulate matter in equipment that is connected to the pipe and driven by the hydraulic fluid. For example, hydraulic valve systems are at risk for being clogged and malfunctioning due to sludge and particulate matter.

As the hydraulic pipe 2 for controlling the valve cannot be flushed through due to being a dead end pipe, a cleaning method is used in which matter is removed from a lumen of a pipe by a back-pulse flushing where carbon dioxide in liquid state LCO2 or supercritical state scCO2 is added to a pipe for the CO2 to diffuse into and through the matter, after which the pressure is reduced. The pressure reduction changes the CO2 into expanding gas that presses the matter out of the pipe at the same end into which the CO2 was inserted. In addition, flushing the pipe 2 when filling CO2 into the pipe is additionally cleaning the walls inside the pipe.

The method is useful for cleaning long dead-end pipes, for example hydraulic control pipes for valves in offshore installations, especially in oil and gas industry. It is advantageously applied in cycles to remove the matter in portions from the pipe.

FIG. 2 is a diagram showing Reynolds numbers from cyclic flushing contaminations in an oil pipe. Due to the Reynolds number of more than 5000, the flushing has been turbulent with a very good cleaning efficiency.

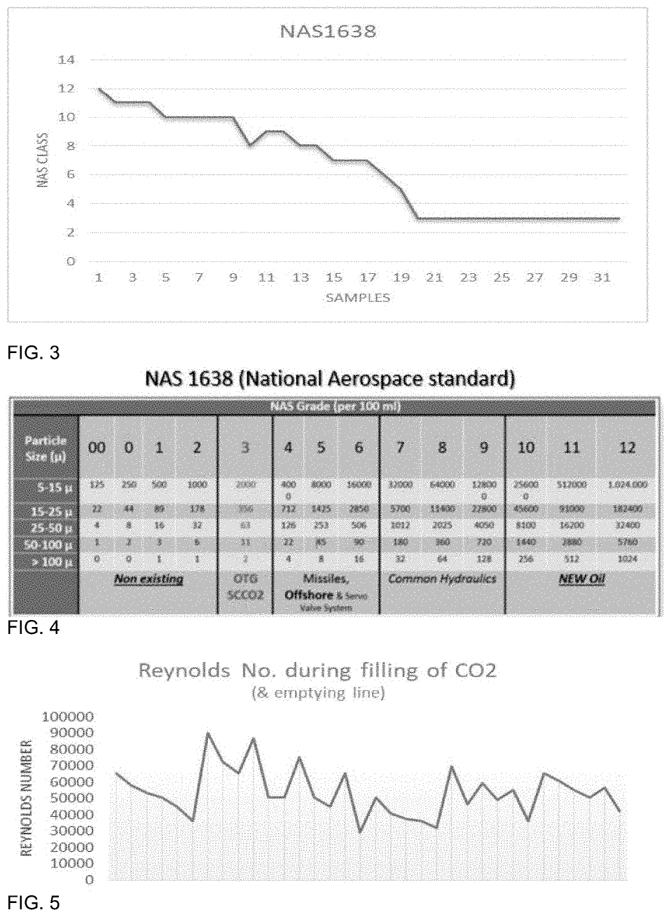

FIG. 3 is a diagram showing the gradual cleanliness of the pipe in terms of a National Aerospace standard (NAS 1638), which is an international standard used for defining cleanliness and the definitions of which is shown in FIG. 4.

FIG. 5 is a diagram Reynolds number during filling of the pipe with scCO2. It is seen that the Reynolds numbers are above 30000, which indicates turbulent flushing with scCO2.

The use of SCCO2 for flushing pipes is superior to flushing with LCO2. This is due to the fact of the lower viscosity as well as for the higher diffusivity. The lower viscosity allows higher flow speed at reduced pressure loss as compared to LCO2. The lower diffusivity results in better penetration of the matter. However, especially for underwater pipes, the temperature cannot always be maintained above the critical temperature of Tc=31° C. why LCO2 may be used instead. Experimentally, useful results have also been obtained with LCO2.

For instances where a pipe is placed in sea water and cooled through the pipe wall by the sea water, the temperature may drop such that a supercritical state cannot be preserved along the entire pipe. In such case, where the CO2 changes into liquid form, variations with respect to pressure loss and speed inside the lumen would occur. However, the flushing would still be possible, although parameters would have to be adjusted. For example, the pressure loss would be higher due to the higher viscosity, and the entrance pressure would have to be chosen correspondingly higher. In order to keep the CO2 in a supercritical state for as much of the pipe length as possible, the flow speed should be adjusted relatively high.

| Item | Reference |
|---|---|
| Offshore installation/rig | 1 |
| Hydraulic pipe | 2 |
| Tube | 3 |
| Sea water | 4 |
| Valve | 6 |
| Well | 7 |

1. A method of removing matter from a lumen of a hydraulic control line (2) by a back-pulse flushing procedure; wherein the back-pulse flushing procedure comprises:
pressurizing the hydraulic control line to a pressure P1 by adding pressurized carbon dioxide into the hydraulic control line (2) at a first end of the hydraulic control line (2);
adding the pressurized carbon dioxide at a temperature T, which at the pressure P1 is in a liquid state, LCO2, or in a supercritical state, scCO2;
maintaining the carbon dioxide in a liquid state or in a supercritical state, respectively, by maintaining the hydraulic control line (2) in the pressurized state for a time t, while the LCO2 or scCO2 diffuses through the matter during the time t and the LCO2 or scCO2 accumulates inside the matter or on the opposite side of the matter or both;
then, after the time t, depressurizing the hydraulic control line (2) at the first end to a lower pressure level P2<P1, for example atmospheric pressure, and causing the carbon dioxide to change into expanding gas inside the hydraulic control line (2) and to press the matter out of the hydraulic control line (2) through the first end of the hydraulic control line (2) by the expanding gas.

2. A method according to claim 1, the method comprises cyclically repeating the back-pulse flushing procedure multiple times.

3. A method according to claim 2, wherein the method comprises pressing the matter through the hydraulic control line (2) to the first end of the hydraulic control line (2) under turbulent conditions.

4. A method according to claim 3, wherein the method comprises adjusting the pressure P1 and the lower pressure level P2 to achieve a velocity of the matter in the hydraulic control line (2) that corresponds to a Reynolds number of at least 3000.

5. A method according to any preceding claim, wherein the method comprises selecting the time t to between 0.1 hour and 72 hours.

6. A method according to any preceding claim, wherein the method comprises pressurizing the hydraulic control line (2) to P1, wherein P1 is in the range of 10,000 kPa (100 bar) to 100,000 kPa (1000 bar).

7. A method according to any preceding claim, wherein the method comprises pressurizing the hydraulic control line (2) to a pressure P1 above the critical pressure, Pc, of carbon dioxide; adding the carbon dioxide as scCO2 at a temperature T in the range of 60 to 200 degrees centigrade.

8. A method according to any preceding claim, wherein the hydraulic control line (2) has a cross sectional area of less than 150 square mm.

9. A method according to any preceding claim, wherein the hydraulic control line is a hydraulic dead-end hydraulic control line for hydraulic actuation of an actuator in a valve of an offshore installation, the hydraulic control line having a cross sectional area of less than 150 square mm and a length of more than 100 m.

10. A method according to any preceding claim, where in the LCO2 or scCO2 is provided with a content of surfactant, wherein the method comprises adjusting the volume of the surfactant relatively to the volume of the LCO2 or scCO2 in the range of 1-5%.

11. A method according to any preceding claim, the method further comprising after removal of the matter, maintaining pressure in the hydraulic control line (2) and adding clean hydraulic liquid while under pressure and removing the CO2 by displacing it with the hydraulic liquid, and then lowering the pressure.

12. A method according to any preceding claim, wherein the method comprises selecting the time t to be between 2 hours and 72 hours.

13. A method according to claims 8 and 12.

14. A method according to claims 9 and 12.

1. A method of removing matter from a lumen of a hydraulic control line by a back-pulse flushing procedure; wherein the back-pulse flushing procedure comprises:
pressurizing the hydraulic control line to a pressure P1 by adding pressurized carbon dioxide into a first end of the hydraulic control line;
adding the pressurized carbon dioxide at a temperature T, which at the pressure P1 is in a liquid state, LCO2, or in a supercritical state, scCO2;
maintaining the carbon dioxide in a liquid state or in a supercritical state, respectively, by maintaining the hydraulic control line in the pressurized state for a time t while the LCO2 or scCO2 diffuses through the matter during the time t and the LCO2 or scCO2 accumulates inside the matter or on the opposite side of the matter or both;
then, after the time t, depressurizing the hydraulic control line at the first end to a lower pressure level P2<P1, for example atmospheric pressure, and causing the carbon dioxide to change into expanding gas inside the hydraulic control line and to press the matter out of the first end of the hydraulic control line by the expanding gas.

2. The method according to claim 1, the method further includes cyclically repeating the back-pulse flushing procedure multiple times.

3. The method according to claim 2, wherein the method further includes pressing the matter through the first end of the hydraulic control line under turbulent conditions.

4. The method according to claim 3, wherein the method further includes adjusting the pressure P1 and the lower pressure level P2 to achieve a velocity of the matter in the hydraulic control line that corresponds to a Reynolds number of at least 3000.

5. The method according to claim 1 wherein the method further includes selecting the time t to between 0.1 hour and 72 hours.

6. The method according to any preceding claim, wherein the method further includes pressurizing the hydraulic control line to P1, wherein P1 is in the range of 10,000 kPa (100 bar) to 100,000 kPa (1000 bar).

7. The method according to claim 1 wherein the method further includes pressurizing the hydraulic control line to a pressure P1 above the critical pressure, Pc, of carbon dioxide; and
adding the carbon dioxide as scCO2 at a temperature T in the range of 60 to 200 degrees centigrade.

8. The method according to claim 1 wherein the hydraulic control line has a cross sectional area of less than 150 square mm.

9. The method according to claim 1 wherein the hydraulic control line is a hydraulic dead-end hydraulic control line configured and arranged for hydraulic actuation of an actuator in a valve of an offshore installation, the hydraulic control line having a cross sectional area of less than 150 square mm and a length of more than 100 m.

10. The method according to claim 1, where in the LCO2 or scCO2 is provided with a content of surfactant, wherein the method further includes adjusting the volume of the surfactant relatively to the volume of the LCO2 or scCO2 in the range of 1-5%.

11. The method according to claim 1 the method further including the step of, after removal of the matter, maintaining pressure in the hydraulic control line [[(2)]]and adding clean hydraulic liquid while under pressure and removing the CO2 by displacing it with the hydraulic liquid, and then lowering the pressure.

12-14. (canceled)

15. The method according to claim 1, wherein the method further includes selecting the time t to be between 2 hours and 72 hours.

16. The method according to claim 8, wherein the method further includes selecting the time t to be between 2 hours and 72 hours.

17. The method according to claim 9, wherein the method further includes selecting the time t to be between 2 hours and 72 hours.
